(19) United States
(12) Patent Application Publication
(10) Pub. No.: US 2026/0183790 A1
(43) Pub. Date: Jul. 2, 2026

(54) FILM FORMING APPARATUS

(71) Applicant: Kabushiki Kaisha Toshiba, Kawasaki-shi (JP)

(72) Inventors: Kenya Uchida, Yokohama Kanagawa (JP); Kenichi Ooshiro, Yokohama Kanagawa (JP); Masahiro Tokoh, Yokohama Kanagawa (JP)

(21) Appl. No.: 19/546,150

(22) Filed: Feb. 20, 2026

Related U.S. Application Data
(63) Continuation of application No. PCT/JP2024/026183, filed on Jul. 22, 2024.

(30) Foreign Application Priority Data
Sep. 21, 2023 (JP) 2023-154181

(51) Int. Cl. B05C 13/00; B65H 20/02; B65H 23/025; F26B 13/10

(52) U.S. Cl. CPC B05C 13/00; B65H 20/02; B65H 23/0251; F26B 13/10; B65H 2301/44324; B65H 2301/5114; B65H 2301/517; B65H 2404/11

(57) ABSTRACT

A film forming apparatus of an embodiment includes an application unit, a drying unit, and a conveyance unit. The application unit applies a raw material liquid to a surface of a substrate, and the drying unit dries the raw material liquid applied to the substrate. The conveyance unit includes a conveyance roll capable of supporting the substrate, and conveys the substrate while passing through an application area in which the raw material liquid is applied and a drying area in which the raw material liquid is dried in order from an upstream side. The conveyance unit conveys the substrate from an upstream end of the application area to a downstream end of the drying area in a state where the substrate does not contact the conveyance roll.

### CROSS-REFERENCE TO RELATED APPLICATIONS

This is a Continuation Application of PCT Application No. PCT/JP 2024/026183, filed Jul. 22, 2024 and based upon and claiming the benefit of priority from prior Japanese Patent Application No. 2023-154181, filed Sep. 21, 2023, the entire contents of which are incorporated herein by reference.

### FIELD

Embodiments described herein relate generally to a film forming apparatus.

### BACKGROUND

In a film forming apparatus that forms a film such as an insulating film on a surface of a substrate such as an electric conductor, a raw material liquid containing an organic material is applied to the surface of the substrate conveyed in a conveyance unit. Then, the substrate is conveyed to a drying area located on a downstream side of an application area in which the raw material liquid is applied. Then, in the drying area, the raw material liquid applied to the substrate is dried to form a film. In a film forming apparatus that forms a film on a substrate as described above, there is required that the substrate is appropriately conveyed, and a film is appropriately formed on the substrate by film forming processing including application of a raw material liquid and drying of the applied raw material liquid.

### BRIEF DESCRIPTION OF DRAWINGS

FIG. 1 is a schematic view illustrating an example of a film forming apparatus according to an embodiment.

FIG. 2 is a cross-sectional view schematically illustrating an example of a coated structure formed by the film forming apparatus according to the embodiment.

FIG. 3 is a perspective view schematically illustrating an example of a configuration of a conveyance roll serving as a position adjustment roll in the film forming apparatus according to the embodiment.

FIG. 4 is a schematic view showing the position adjustment roll of FIG. 3 as viewed from a direction orthogonal or substantially orthogonal to a center axis.

FIG. 5 is a perspective view schematically illustrating another example of the configuration of the conveyance roll serving as the position adjustment roll different from FIGS. 3 and 4 in the film forming apparatus according to the embodiment.

FIG. 6 is a schematic view illustrating the position adjustment roll of FIG. 5 as viewed from a direction orthogonal or substantially orthogonal to the center axis.

### DETAILED DESCRIPTION

The film forming apparatus according to the embodiment includes an application unit, a drying unit, and a conveyance unit. The application unit applies a raw material liquid to a surface of a substrate, and the drying unit dries the raw material liquid applied to the substrate by the application unit. The conveyance unit includes a conveyance roll capable of supporting the substrate, and conveys the substrate while passing through an application area in which the raw material liquid is applied by the application unit and a drying area in which the raw material liquid is dried by the drying unit in order from an upstream side. The conveyance unit conveys the substrate from an upstream end of the application area to a downstream end of the drying area in a state where the substrate does not contact the conveyance roll.

Hereinafter, embodiments will be described with reference to the drawings.

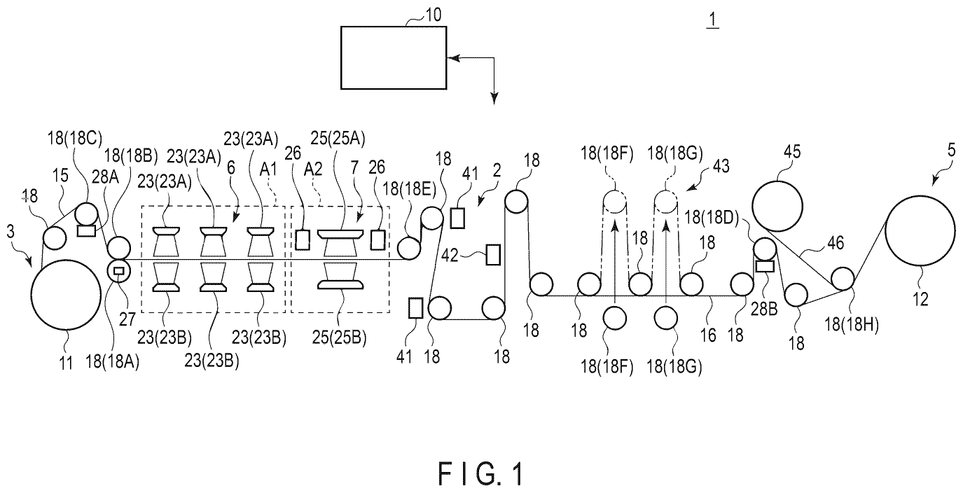

FIG. 1 schematically illustrates an example of a film forming apparatus 1 according to an embodiment. As illustrated in FIG. 1 and the like, the film forming apparatus 1 includes a conveyance unit 2, an unwinding unit 3, a winding unit 5, an application unit 6, a drying unit 7, and a control unit 10. In the film forming apparatus 1, the unwinding unit 3 includes a reel (unwinding reel) 11, and a substrate (base member) 15 is wound around the reel 11. Then, with rotation of the reel 11, the substrate 15 wound around the reel 11 is unwound to the conveyance unit 2. Then, a film (not illustrated in FIG. 1) such as an insulating film is formed on a surface of the substrate 15 by performing film forming processing on the substrate 15 conveyed in the conveyance unit 2 using the application unit 6 and the drying unit 7. That is, a coated structure 16 in which a film is coated on the substrate 15 is formed by film forming processing. In the film forming apparatus 1, the winding unit 5 includes a reel (winding reel) 12, and the coated structure 16 is wound by rotating the reel 12.

In the conveyance unit 2, a conveyance direction in which the substrate 15 is conveyed, that is, a direction toward the winding unit 5 is a downstream side. In the conveyance unit 2, a direction opposite to the conveyance direction, that is, a direction toward the unwinding unit 3 is an upstream side. In the conveyance unit 2 (film forming apparatus 1), a width direction intersecting (orthogonal or substantially orthogonal to) the conveyance direction is defined. In FIG. 1, a width direction of the conveyance unit 2 is orthogonal or substantially orthogonal to the paper surface. In the example of FIG. 1, the substrate 15 is conveyed from the unwinding unit 3 to the winding unit 5 in a roll-to-roll manner. Each of the reels 11 and 12 rotates about a center axis along the width direction of the conveyance unit 2, and an axial direction of each of the reels 11 and 12 is along the width direction of the conveyance unit.

Further, the conveyance unit 2 is provided with conveyance rolls 18 capable of supporting the substrate 15 to be conveyed, and in the example of FIG. 1, a plurality of conveyance rolls 18 is provided in the conveyance unit 2. Each of the conveyance rolls 18 has a center axis along the width direction of the conveyance unit 2 and is rotatable about the center axis. Each of the conveyance rolls 18 supports the substrate 15 to be conveyed by, for example, being in contact with the substrate 15. Each of the conveyance rolls 18 comes into contact with the substrate 15 from a direction intersecting both the conveyance direction and the width direction of the conveyance unit 2. In a preferred example, a diameter of each of the plurality of conveyance rolls 18 is 100 mm or more.

The control unit 10 controls the entire operation of the film forming apparatus 1, and controls conveyance of the substrate 15 in the conveyance unit 2, film forming processing for forming a film on the substrate 15, and the like. The control unit 10 includes a processor or an integrated circuit (control circuit) including a central processing unit (CPU), an application specific integrated circuit (ASIC), a field programmable gate array (FPGA), or the like, and a storage medium (non-transitory storage medium) such as a memory. The control unit 10 may include only one integrated circuit or the like, or may include a plurality of integrated circuits or the like. The control unit 10 performs processing by executing a program or the like stored in a storage medium or the like.

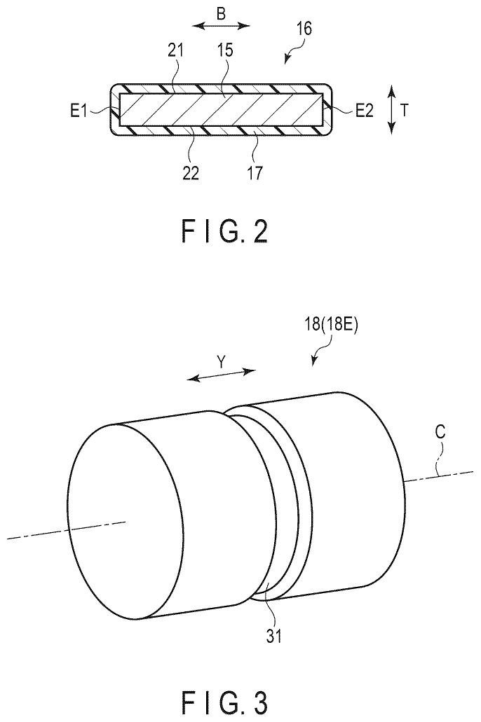

FIG. 2 illustrates an example of the coated structure 16 formed by the film forming apparatus 1. In the example of FIG. 2, a conductor having conductivity is used as the substrate 15, and an insulating film having electrical insulation is formed as a film 17 on the surface of the substrate 15 by the film forming apparatus 1. Therefore, a coating conductor in which the conductor is coated with the insulating film is formed as the coated structure 16. In the substrate 15, a longitudinal direction (a direction orthogonal or substantially orthogonal to the paper surface of FIG. 2), a width direction (a direction indicated by an arrow B in FIG. 2) intersecting (orthogonal or substantially orthogonal to) the longitudinal direction, and a thickness direction (a direction indicated by an arrow T in FIG. 2) intersecting (orthogonal or substantially orthogonal to) both the longitudinal direction and the width direction are defined. In the substrate 15, a dimension along the longitudinal direction is larger than a dimension along the width direction, and a dimension along the width direction is larger than a dimension along the thickness direction. FIG. 2 illustrates a cross section orthogonal or substantially orthogonal to the longitudinal direction of the substrate 15.

The substrate 15 includes a pair of main surfaces 21 and 22. The main surface 21 faces one side in the thickness direction, and the main surface 22 faces a side opposite to the main surface 21 in the thickness direction. In the example of FIG. 2, both the main surfaces 21 and 22 of the substrate 15 are covered with the film 17. An edge E1 on one side in the width direction and an edge E2 on a side opposite to the edge E1 in the width direction are formed in the substrate 15. In the example of FIG. 2, the film 17 is coated on each of the edges E1 and E2.

In one example, a superconductor such as a superconducting wire is used as the substrate 15, and an insulating film is formed as the film 17 on the surface of the substrate 15 including the main surfaces 21 and 22. Then, a coated superconductor such as a coated superconducting wire is formed as the coated structure 16. In a case where the superconductor is used as the substrate 15, the substrate 15 contains, for example, any one of a niobium-titanium alloy, a niobium-tin compound, a niobium-aluminum compound, a magnesium diboride, a bismuth-based oxide, and an yttrium-based oxide as a superconducting material. In a case where the coated superconducting wire is formed as the coated structure 16, for example, the superconducting wire having a dimension in the width direction of 3 mm or more and 20 mm or less is used as the substrate 15.

In the film forming apparatus 1 of the example of FIG. 1, the substrate 15 is conveyed from the upstream side to the downstream side in the conveyance unit 2 as described above. At this time, the substrate 15 is conveyed in a state where a longitudinal direction of the substrate 15 is along the conveyance direction in the conveyance unit 2 and a width direction of the substrate 15 is along the width direction of the conveyance unit 2. That is, the substrate 15 is conveyed in a state where the thickness direction of the substrate 15 intersects (is orthogonal or substantially orthogonal to) both the conveyance direction and the width direction of the conveyance unit 2. Each of the conveyance rolls 18 supports the conveyed substrate 15 by, for example, being in contact with the substrate 15 from one side in the thickness direction of the substrate 15.

In the film forming apparatus 1, the application unit 6 applies the raw material liquid to the surface of the substrate 15 conveyed by the conveyance unit 2. Then, the drying unit 7 dries the raw material liquid applied by the application unit 6. In the film forming apparatus 1, the film 17 is formed on the surface of the substrate 15 by performing the film forming processing including application of the raw material liquid by the application unit 6 and drying of the raw material liquid by the drying unit 7. In the conveyance unit 2 of the film forming apparatus 1, the raw material liquid is applied to the substrate 15 by the application unit 6 in an application area A1. In the conveyance unit 2, the drying unit 7 dries the raw material liquid applied to the substrate 15 in a drying area A2.

In the conveyance unit 2, the drying area A2 is located on the downstream side relative to the application area A1. Therefore, the substrate 15 is conveyed through the application area A1 and the drying area A2 in order from the upstream side. Therefore, in the conveyance unit 2, the substrate 15 applied with the raw material liquid in the application area A1 is conveyed to the drying area A2 located on the downstream side of the application area A1. Then, in the drying area A2, the raw material liquid applied to the substrate 15 is dried.

In the example of FIG. 1, the drying area A2 is provided adjacent to the application area A1 from the downstream side, and is continuous to the downstream side of the application area A1. That is, the conveyance roll 18 or the like that supports the substrate 15 is not provided between the application area A1 and the drying area A2. In the example of FIG. 1, the conveyance roll 18 or the like that supports the substrate 15 is not provided in each of the application area A1 and the drying area A2. Therefore, in the conveyance unit 2 in the example of FIG. 1, the conveyance roll 18 is not disposed between the upstream end of the application area A1 and the downstream end of the drying area A2. Therefore, the conveyance unit 2 conveys the substrate 15 in a state where the substrate 15 is not in contact with the conveyance roll 18 from the upstream end of the application area A1 to the downstream end of the drying area A2.

The raw material liquid applied to the substrate 15 is produced by dissolving an organic substance in a solvent. As the organic substance used in the raw material liquid, for example, any one or more of polyolefin, polyether, polyimide, polyketone, polysulfone, cellulose, polyvinyl alcohol (PVA), polyamide, polyamideimide, and polyvinylidene fluoride (PVdf) are selected. Examples of the polyolefin include polypropylene (PP) and polyethylene (PE).

As the solvent that dissolves the organic substance in the raw material liquid, any one of dimethylacetamide (DMAc), dimethylsulfoxide (DMSO), N, N-dimethylformamide (DMF), N-methylpyrrolidone (NMP), acetone, dimethoxyethylene, toluene, tetrahydrofuran, water, alkanes, ketones, esters, alcohols, ethers, and the like is used. In the raw material liquid, for example, the organic substance is dissolved in the solvent at a concentration of 5% by mass or more and 60% by mass or less.

The application unit 6 includes an application head 23, and in the example of FIG. 1, a plurality of application heads 23 is disposed in the application area A1. The film forming apparatus 1 includes a supply unit (not illustrated) that supplies a raw material liquid to each of the application heads 23. In one example, the supply unit includes a tank that stores the raw material liquid, and a supply drive unit such as a supply pump. Then, the control unit 10 controls driving of the supply drive unit and the like to supply the raw material liquid from the tank to each of the application heads 23. Each of the application heads 23 discharges the supplied raw material liquid toward the conveyed substrate 15. With discharge of the raw material liquid from each of the application heads 23, the raw material liquid is applied to the surface of the substrate 15 in the application area A1.

In one example, each of the application heads 23 discharges the raw material liquid toward the substrate 15 by an electrospinning method (also referred to as a charge spinning method, a charge induction spinning method, or the like). In this case, the film forming apparatus 1 includes an electric power source (not illustrated) such as a DC power source. Then, for example, the electric power source applies a voltage to each of the application heads 23 to generate an electric potential difference between the conveyed substrate 15 and each of the application heads 23. As a result, in each of the application heads 23, the raw material liquid supplied from the supply unit is charged by the application of the applied voltage, and each of the application heads 23 discharges the charged raw material liquid toward the substrate 15.

The control unit 10 appropriately adjusts the voltage between each of the application heads 23 and the substrate 15 in accordance with the types of the solvent and the solute in the raw material liquid, a boiling point and a vapor pressure curve of the solvent of the raw material liquid, concentration and temperature of the raw material liquid, a distance between the substrate 15 and the application head 23, and the like. In one example, a voltage (electric potential difference) applied between each of the application heads 23 and the substrate 15 is appropriately adjusted between 1 kV and 100 kV.

In one example, a voltage is applied to any one of a supply source of the raw material liquid to the application head 23 and a supply path of the raw material liquid between the supply source and the application head 23 by the above-described electric power source or the like to charge the raw material liquid. Also in this case, the charged raw material liquid is discharged from each of the application heads 23 toward the substrate 15, and the raw material liquid is discharged from each of the application heads 23 by the electrospinning method. Further, the discharge of the raw material liquid from the application head 23 may be performed by a method other than the electrospinning method. In one example, the raw material liquid is discharged from each of the application heads 23 to the substrate 15 by a solution blow method instead of the electrospinning method.

In the application area A1, a height direction intersecting both the conveyance direction and the width direction of the conveyance unit 2 is defined. Then, in the application area A1, the substrate 15 is conveyed in a state where the thickness direction of the substrate 15 is along the height direction. In the example of FIG. 1, the plurality of application heads 23 includes application heads 23A that discharge the raw material liquid from one side in the height direction (thickness direction of the substrate 15) toward the substrate 15, and application heads 23B that discharge the raw material liquid from a side opposite to the application head 23A toward the substrate 15 in the height direction. For example, the application head 23A discharges the raw material liquid from a side where the main surface 21 faces, and the application head 23B discharges the raw material liquid from a side where the main surface 22 faces, for example.

In the example of FIG. 1, a plurality of the application heads 23A and a plurality of the application heads 23B are provided. Then, each of the application heads 23A is not shifted or hardly shifted in the conveyance direction from the corresponding one of the application heads 23B. Therefore, in a state where the substrate 15 is conveyed, each of the application heads 23A faces the corresponding one of the application heads 23B with the substrate 15 interposed therebetween.

In the application area A1, each of the application heads 23A may be arranged to be shifted in the conveyance direction from any of the application heads 23B. In one example, the application heads 23A and the application heads 23B that discharges the raw material liquid from the side opposite to the application head 23A in the height direction are alternately arranged along the conveyance direction. In another example, each of the application heads 23B is disposed on the downstream side relative to any of the application heads 23A. In this case, a portion where all the application heads 23B are arranged along the conveyance direction is formed on the downstream side of a portion where all the application heads 23A are arranged along the conveyance direction.

Further, both the application heads 23A and 23B are not necessarily provided as the application heads 23. In one example, only one of the application heads 23A and 23B is provided, and in the application area A1, the raw material liquid is discharged to the substrate 15 only from one side in the height direction. However, in a case where the coated superconductor is formed as the coated structure 16, the raw material liquid is applied to both the main surfaces 21 and 22 of the substrate 15 even in a configuration in which the raw material liquid is discharged to the substrate 15 only from one side in the height direction. Then, the film 17 serving as an insulating film is formed on both the main surfaces 21 and 22 of the substrate 15.

The drying unit 7 includes dryers 25, and the dryer 25 dries the raw material liquid applied to the substrate 15 by performing at least one of blowing and heating. At this time, the raw material liquid is dried by volatilizing the solvent contained in the raw material liquid. In one example, the drying unit 7 includes a blower as the dryer 25, and a flow of gas from the blower toward the conveyed substrate 15 is formed by air blowing from the blower. Then, with supply of a dry gas or the like from the blower to the substrate 15, the raw material liquid applied to the substrate 15 is dried. In the configuration in which the raw material liquid is dried by blowing air from the blower, heated gas or the like may be supplied as hot air from the blower toward the substrate 15.

In another example, the dryer 25 includes a heater such as an infrared heater. In the drying area A2, the substrate 15 to be conveyed and the raw material liquid applied to the substrate 15 are heated by the heater. For example, in a configuration in which an infrared heater is provided as the heater, infrared rays are emitted from the infrared heater toward the substrate 15, and the substrate 15 and the raw material liquid are heated by the infrared rays from the infrared heater. The dryer 25 dries the raw material liquid applied to the substrate 15 by heating from the heater. In one example, the dryer 25 includes both a blower and a heater, and dries the raw material liquid applied to the substrate 15 by both blowing air from the blower and heating from the heater.

In the drying area A2, a height direction crossing both the conveyance direction and the width direction of the conveyance unit 2 is defined. In the drying area A2, the substrate 15 is conveyed in a state where the thickness direction of the substrate 15 is along the height direction. In the example of FIG. 1, the drying unit 7 includes dryers 25A and 25B as the dryers 25. In the drying area A2, the substrate 15 is conveyed through between the dryers 25A and 25B in the height direction. Thus, the dryer 25A faces the substrate (base member) 15 from one side in the height direction, and performs at least one of blowing air to the substrate 15 and heating of the substrate 15 from one side in the height direction. The dryer 25B faces the substrate 15 from a side opposite to the dryer 25A in the height direction, and performs at least one of blowing air to the substrate 15 and heating of the substrate 15 from the side opposite to the dryer 25A in the height direction.

Note that both the dryers 25A and 25B are not necessarily provided as the dryer 25. In one example, only one of the dryers 25A and 25B is provided, and in the drying area A2, air is blown to the substrate 15 and/or the substrate 15 is heated, only from one side in the height direction. In the example of FIG. 1, temperature sensors 26 are disposed in the drying area A2. The temperature sensor 26 detects a temperature of the substrate 15 without contacting the conveyed substrate 15. In the example of FIG. 1, in the drying area A2, the temperature sensor 26 is disposed at each of a position adjacent to the dryers 25A and 25B from the upstream side and a position adjacent to the dryers 25A and 25B from the downstream side.

The control unit 10 acquires a detection result of the temperature of the substrate 15 by the temperature sensor 26. The control unit 10 controls operation of the dryer 25 based on the detection result of the temperature of the substrate 15 to adjust the temperature of the base material 15 in the drying area A2. At this time, the control unit 10 controls operation of the dryer 25 in a state where the temperature of the substrate 15 is lower than a threshold temperature. In one example, a superconductor as the substrate 15 is conveyed in the conveyance unit 2. Then, the control unit 10 controls the operation of the dryer 25 in accordance with the detection result of the temperature sensor 26 in a state where the temperature of the substrate 15 in the drying area A2 is lower than 200° C.

In addition, in the film forming apparatus 1, the conveyance speed of the substrate 15 conveyed in the conveyance unit 2 is controlled. In the example of FIG. 1, an encoder 27 is attached to a conveyance roll 18A which is one of the conveyance rolls 18. The conveyance roll 18A is disposed on the upstream side relative to the application area A1. The encoder 27 detects the rotation speed of the conveyance roll 18A. In a state where the substrate 15 is conveyed, the control unit 10 calculates the conveyance speed of the substrate 15 on the basis of the detection result of a rotation speed of the conveyance roll 18A. Then, the control unit 10 controls the conveyance speed of the substrate 15 on the basis of the calculation result of the conveyance speed of the substrate 15.

In the example of FIG. 1, the conveyance rolls 18A and 18B sandwich the conveyed substrate 15 being conveyed therebetween, and a nip pressure acts on the substrate 15 by the conveyance rolls 18A and 18B. One of the conveyance rolls 18A and 18B is rotated by a driving force from a motor (not illustrated). The control unit 10 controls the driving of the motor on the basis of a calculation result of the conveyance speed, and adjusts the rotation speed of the conveyance roll (18A or 18B) rotated by a driving force from the motor. The control unit 10 controls a conveyance speed of the substrate 15 by adjusting a rotation speed of the conveyance roll (18A or 18B) as described above. At this time, the control unit 10 controls the conveyance speed of the substrate 15 in a state where the conveyance speed of the substrate 15 is maintained in a reference speed range.

In the example of FIG. 1, the conveyance roll 18A whose rotation speed is detected and the conveyance roll (18A or 18B) whose rotation speed is adjusted by the drive control of the motor are disposed on the upstream side of the application area A1. However, in the embodiment, the conveyance speed of the substrate 15 may be adjusted in a region located on the downstream side of the drying area A2 in the same manner as in the example of FIG. 1. In this case, the conveyance roll 18 whose rotation speed is detected and the conveyance roll 18 whose rotation speed is adjusted by the drive control of the motor are disposed on the downstream side of the drying area A2.

Further, in the film forming apparatus 1, a tension acting on the substrate 15 conveyed in the conveyance unit 2 is controlled. In the example of FIG. 1, a tension sensor 28A is attached to a conveyance roll 18C that is one of the conveyance rolls 18 different from the conveyance rolls 18A and 18B, and a tension sensor 28B is attached to the conveyance roll 18D that is one of the conveyance rolls 18 different from conveyance rolls 18A to 18C. The conveyance roll 18C is disposed on the upstream side of the application area A1, and the conveyance roll 18D is disposed on the downstream side of the drying area A2. The tension sensor 28A detects a tension acting on the substrate 15 in the conveyance roll 18C, and the tension sensor 28B detects a tension acting on the substrate 15 in the conveyance roll 18D.

The control unit 10 controls the tension acting on the substrate 15 on the basis of the detection results of the tension acting on the substrate 15 by the tension sensors 28A and 28B. In one example, in the film forming apparatus 1, one or more of the conveyance rolls 18 are movable, and for example, each of the conveyance rolls 18C and 18D is movable. Then, the position of the movable conveyance roll 18 changes so that the tension acting on the conveyed substrate 15 changes. The control unit 10 adjusts the position of the movable conveyance roll 18 on the basis of the detection results of the tension in the tension sensors 28A and 28B, and adjusts the tension acting on the conveyed substrate 15. At this time, the control unit 10 controls the tension acting on the substrate 15 in a state where the tension acting on the substrate 15 is maintained in a reference tension range.

In another example, the unwinding unit 3 is provided with a brake mechanism that applies a brake torque to the unwinding operation of the substrate 15 from the reel 11. Then, the control unit 10 adjusts the brake torque applied from the brake mechanism based on the detection results of the tension in the tension sensors 28A and 28B, and adjusts the tension acting on the conveyed substrate 15. In still another example, the control unit 10 adjusts a rotational torque applied to the reel 12 of the winding unit 5 in the winding of the substrate 15 around the reel 12 based on the detection results of the tension in the tension sensors 28A and 28B. Then, the control unit 10 adjusts the tension acting on the conveyed substrate 15 by adjusting the rotational torque of the reel 12.

The control unit 10 may adjust the tension acting on the conveyed substrate 15 by performing two or more of adjustment of the position of the movable conveyance roll 18, adjustment of the brake torque on the unwinding operation of the substrate 15 in the unwinding unit 3, and adjustment of the rotational torque of the reel 12 of the winding unit 5. Therefore, in the adjustment of the tension acting on the substrate 15, one or more of the adjustment of the position of the movable conveyance roll 18, the adjustment of the brake torque on the unwinding operation of the substrate 15 in the unwinding unit 3, and the adjustment of the rotational torque of the reel 12 of the winding unit 5 may be performed.

In the example of FIG. 1, the tension acting on the substrate 15 is detected by each of the conveyance roll 18C disposed on the upstream side of the application area A1 and the conveyance roll 18D disposed on the downstream side of the drying area A2. However, in the embodiment, the tension acting on the substrate 15 may be detected only in one of the regions located on the upstream side of the application area A1 and located on the downstream side of the drying area A2. Also, in this case, the tension acting on the substrate 15 is controlled in the same manner as in any of the examples described above.

In the example of FIG. 1, a position of the substrate 15 in the width direction of the conveyance unit 2 is adjusted by a conveyance roll 18E which is one of the conveyance rolls 18 different from the conveyance rolls 18A to 18D. That is, the conveyance roll 18E is a position adjustment roll that adjusts the position of the substrate 15 in the width direction of the conveyance unit 2. The conveyance roll 18E is disposed at a position adjacent to the drying area A2 from the downstream side. Therefore, in the conveyance unit 2, the position of the substrate 15 is adjusted by the conveyance roll 18E immediately after passing through the application area A1 and the drying area A2 in order, that is, immediately after passing through an area not in contact with the conveyance roll 18 or the like. The conveyance roll 18E, which is a position adjustment roll, adjusts the position of the substrate 15 in the width direction of the conveyance unit 2 without generating torsion in the substrate 15.

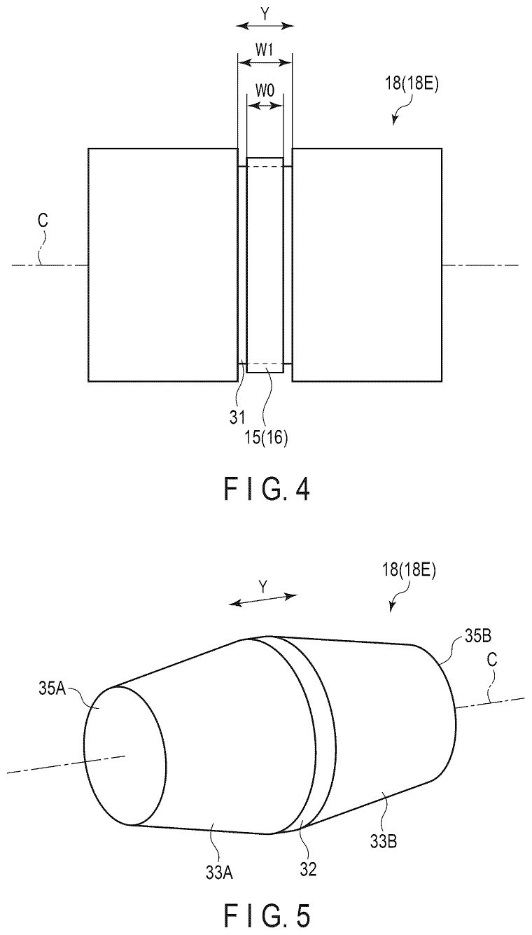

FIGS. 3 and 4 show an example of a configuration of the conveyance roll 18E serving as a position adjustment roll. In FIGS. 3 and 4, a direction indicated by an arrow Y is the width direction of the conveyance unit 2, and coincides with or substantially coincides with the axial direction of the conveyance roll 18E which is the direction along the center axis C of the conveyance roll 18E. Here, FIG. 3 is a perspective view, and FIG. 4 illustrates a state viewed from a direction orthogonal or substantially orthogonal to the center axis C of the conveyance roll 18E.

In the example of FIGS. 3 and 4, the conveyance roll 18E includes a recess 31 formed on an outer peripheral surface of the conveyance roll 18E, and the recess 31 is recessed toward an inner peripheral side on the outer peripheral surface of the conveyance roll 18E. The recess 31 is formed along a circumferential direction of the conveyance roll 18E. In the example of FIGS. 3 and 4, the recess 31 is formed over the entire circumference of the conveyance roll 18E, and the recess 31 is formed at the central portion of the conveyance roll 18E in the axial direction of the conveyance roll 18E (width direction of the conveyance unit 2). An outer diameter of the conveyance roll 18E in an area where the recess 31 is formed is smaller than an outer diameter of the conveyance roll 18E in an area other than the recess 31.

In addition, a dimension (width dimension) W0 of the substrate 15 along the width direction and a dimension W1 of the recess 31 along the axial direction (width direction of the conveyance unit 2) of the conveyance roll 18E are defined. The dimension W0 of the substrate 15 is smaller than dimension W1 of the recess 31. In a preferred example, a value obtained by subtracting the dimension W0 of the substrate 15 from the dimension W1 of the recess 31 is 1 mm or more and 2 mm or less. That is, a relationship of W0+1 mm≤W1≤W0+2 mm is established. The conveyance roll 18E supports the conveyed substrate 15 in a state where the entire width of the substrate 15 is accommodated in the recess 31. The conveyance roll 18E supports the substrate 15 in a state where a bottom surface of the recess 31 is in contact with the substrate 15 to be conveyed.

Since the substrate 15 is conveyed in a state where the entire width of the substrate 15 is accommodated in the recess 31, in the conveyance roll 18E, the movement of the substrate 15 in the width direction of the conveyance unit 2 is restricted by the recess 31 (side surfaces of the recess 31). Therefore, the substrate 15 to be conveyed is prevented from deviating in the width direction of the conveyance unit 2 beyond the recess 31. Therefore, the deviation of the substrate 15 caused by the substrate 15 moving toward one side in the width direction of the conveyance unit 2 and meandering of the substrate 15 are suppressed by the conveyance roll 18E serving as the position adjustment roll.

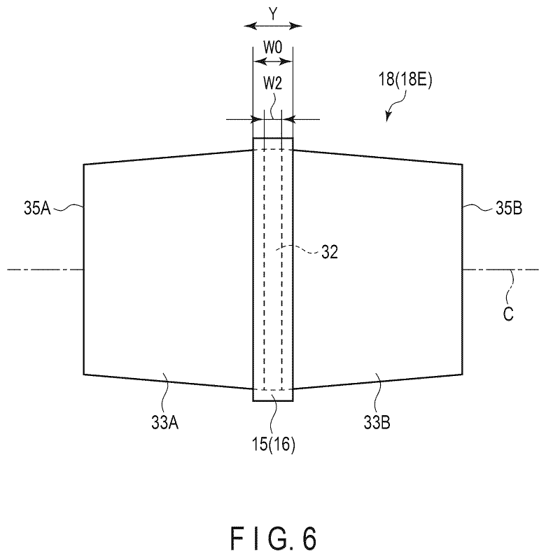

FIGS. 5 and 6 show another example of the configuration of the conveyance roll 18E serving as the position adjustment roll different from FIGS. 3 and 4. In FIGS. 5 and 6, a direction indicated by the arrow Y is the width direction of the conveyance unit 2, and coincides with or substantially coincides with the axial direction of the conveyance roll 18E which is the direction along the center axis C of the conveyance roll 18E. Here, FIG. 5 is a perspective view, and FIG. 6 illustrates a state viewed from a direction orthogonal or substantially orthogonal to the center axis C of the conveyance roll 18E.

In the example of FIGS. 5 and 6, the conveyance roll 18E includes a uniform diameter portion 32 and tapered portions 33A and 33B. In the conveyance roll 18E, the tapered portion (first tapered portion) 33A is adjacent to the uniform diameter portion 32 from one side in the axial direction (width direction of the conveyance unit 2). The tapered portion (second tapered portion) 33B is adjacent to the uniform diameter portion 32 from the opposite side of the tapered portion 33A in the axial direction (width direction of the conveyance unit 2). Therefore, the uniform diameter portion 32 is formed between the tapered portions 33A and 33B in the width direction of the conveyance unit 2. In the example of FIGS. 5 and 6, the uniform diameter portion 32 is formed in a central portion of the conveyance roll 18E in the axial direction of the conveyance roll 18E (the width direction of the conveyance unit 2).

In the uniform diameter portion 32, an outer diameter of the conveyance roll 18E does not change or hardly changes between a connection position with the tapered portion 33A and a connection position with the tapered portion 33B. That is, in the uniform diameter portion 32, an outer diameter of the conveyance roll 18E is uniform. In each of the tapered portions 33A and 33B, an outer diameter of the conveyance roll 18E decreases as a distance in the tapered portion from the uniform diameter portion 32 increases in the axial direction of the conveyance roll 18E (width direction of the conveyance unit 2).

Here, in the conveyance roll 18E, an end surface 35A on one side in the axial direction and an end surface 35B on a side opposite to the end surface 35A in the axial direction are defined. In the example of FIGS. 5 and 6, the tapered portion 33A extends along the axial direction of the conveyance roll 18E (the width direction of the conveyance unit 2) from the connection position with the uniform diameter portion 32 to the end surface 35A. The tapered portion 33B extends from the connection position with the uniform diameter portion 32 to the end surface 35B along the axial direction of the conveyance roll 18E. Therefore, in the example of FIGS. 5 and 6, in the uniform diameter portion 32, the conveyance roll 18E has the maximum outer diameter, and a crown roll is used as the conveyance roll 18E.

In addition, a dimension (width dimension) W0 of the substrate 15 along the width direction and a dimension W2 of the uniform diameter portion 32 along the axial direction (width direction of the conveyance unit 2) of the conveyance roll 18E are defined. In the embodiment and the like, the dimension W2 of the uniform diameter portion 32 is twice or less of the dimension W0 of the substrate 15. However, in the configuration of the example of FIGS. 5 and 6, the dimension W2 of the uniform diameter portion 32 is preferably equal to or less than the dimension W0 of the substrate 15. The dimension W2 of the uniform diameter portion 32 is preferably 1 mm or more. Therefore, in a case where the dimension W0 of the substrate 15 is about 3 mm, the dimension W2 of the uniform diameter portion 32 is preferably 1 mm or more and 3 mm or less. In a case where the dimension W0 of the substrate 15 is 3 mm or more and the dimension W2 of the uniform diameter portion 32 is equal to or less than the dimension W0 of the substrate 15, a value obtained by subtracting the dimension W2 of the uniform diameter portion 32 from the dimension W0 of the substrate 15 is more preferably 2 mm or more. That is, it is more preferable that a relationship of W2≤W0−2 mm (W0≥3 mm) be satisfied.

The conveyance roll 18E serving as a position adjustment roll supports the substrate 15 being conveyed in a state where the uniform diameter portion 32 is in contact with the substrate 15 from the inner peripheral side. As described above, in the rotation of the conveyance roll 18E including the uniform diameter portion 32 and the tapered portions 33A and 33B, a peripheral speed of the uniform diameter portion 32 is faster than a peripheral speed of each of the tapered portions 33A and 33B. Therefore, in the substrate 15 supported by the conveyance roll 18E, an acting tension is larger at the contact portion with the uniform diameter portion 32 than at the contact portion with each of the tapered portions 33A and 33B.

Therefore, when the conveyance roll 18E conveys the substrate 15 in a state where the uniform diameter portion 32 is in contact with the substrate 15, the conveyance roll 18E causes a force of attracting the substrate 15 to an area where the uniform diameter portion 32 is located in the width direction of the conveyance unit 2 (the axial direction of the conveyance roll 18E) to act on the substrate 15. As a result, the deviation of the substrate 15 caused by the substrate 15 moving toward one side in the width direction of the conveyance unit 2 and meandering of the substrate 15 are suppressed by the conveyance roll 18E serving as the position adjustment roll.

In any of the examples of FIGS. 3 and 4 and the examples of FIGS. 5 and 6, the conveyance roll 18E serving as the position adjustment roll adjusts the position of the substrate 15 in the width direction of the conveyance unit 2 without generating twisting in the substrate 15. Then, due to a structure of the conveyance roll 18E itself and a support structure of the substrate 15 by the conveyance roll 18E, the position of the substrate 15 in the width direction of the conveyance unit 2 is adjusted. Therefore, the position of the substrate 15 in the width direction of the conveyance unit 2 is adjusted without performing operation control or the like by the control unit 10. That is, the position of the substrate 15 is adjusted in the conveyance roll 18E without providing a control system or the like by the control unit 10.

Here, the position adjustment of the substrate 15 in the width direction of the conveyance unit 2 performed by the conveyance roll 18E as described above is different from a mechanism that corrects meandering and deviation of the substrate 15 by controlling the operation of the operation unit or the like. In the mechanism for correcting the meandering or the like of the substrate 15, a sensor for detecting the meandering or the like of the substrate 15 and an operation unit such as a roll guider are provided. In a case where the sensor detects meandering or the like of the substrate 15, the operation unit is operated by the operation control of the operation unit to correct the generated meandering or the like of the substrate 15. At this time, for example, meandering or the like of the substrate 15 is corrected by inclining the conveyance roll of the roll guider serving as the operation unit. In the example of FIG. 1, a mechanism for correcting meandering or the like of the substrate 15 by controlling the operation of the operation unit or the like is not provided.

In addition, one or more of the conveyance rolls 18 other than the conveyance roll 18E may be formed in the same configuration as the conveyance roll 18E. In this case, for example, one or more conveyance rolls 18 other than the conveyance roll 18E are formed similarly to any one of the examples of FIGS. 3 and 4 and the examples of FIGS. 5 and 6. With such a configuration, in addition to the conveyance roll 18E, one or more conveyance rolls 18 other than the conveyance roll 18E serve as position adjustment rolls, and each of the position adjustment rolls adjusts the position of the substrate 15 in the width direction of the conveyance unit 2 without generating torsion in the substrate 15.

In the example of FIG. 1, an inspection for the substrate 15, the film 17 formed on the substrate 15, and the like is performed in a region located on the downstream side of the drying area A2 and the conveyance roll 18E. In the film forming apparatus 1, film thickness measuring instruments 41 are disposed on the downstream side relative to the conveyance roll 18E. The film thickness measuring instrument 41 measures the film thickness of the film 17 formed on the surface of the substrate 15 by the application unit 6 and the drying unit 7. In the inspection for the film 17, whether or not the film 17 is appropriately formed on the substrate 15 is determined based on the measurement result of the film thickness of the film 17.

In one example, the film thickness measuring instrument 41 includes an optical system, and measures the film thickness of the film 17 by an optical interference method. In another example, the film thickness measuring instrument 41 captures the conveyed substrate 15 (coated structure 16) or the like to acquire an image of the film 17 formed on the surface of the substrate 15. Then, the film thickness measuring instrument 41 calculates a color density of the film 17 in the acquired image. Then, the film thickness measuring instrument 41 calculates the film thickness of the film 17 based on the color density of the film 17 in the image and a calibration curve indicating a relationship between the color density of the film 17 and the film thickness.

In addition, in the film forming apparatus 1 of the example of FIG. 1, a detector 42 that detects a deterioration state of the substrate 15 is disposed in a region located on the downstream side of the conveyance roll 18E. The detector 42 detects a physical quantity indicating the deterioration state of the conveyed substrate 15. In one example, a superconductor is conveyed as the substrate 15, and the detector 42 detects an Ic value (critical current value) of the substrate 15 as a physical quantity indicating the deterioration state of the substrate 15 by a Hall element method. In this case, the detector 42 measures the Ic value of the substrate 15 using, for example, “Tapestar (Japanese registered trademark) XL” manufactured by THEVA GmbH. In the inspection for the substrate 15, it is determined whether or not the substrate 15 has deteriorated beyond a reference level based on the detection result of the physical quantity indicating the deterioration state of the substrate 15.

In the example of FIG. 1, an accumulator 43 is provided on the downstream side relative to the drying area A2 and the conveyance roll 18E. The accumulator 43 is disposed on the downstream side relative to an area where the inspection is performed using the film thickness measuring instrument 41, the detector 42, and the like. In the example of FIG. 1, the accumulator 43 includes five conveyance rolls 18, and two conveyance rolls 18F and 18G among the five conveyance rolls 18 are movable. Each of the conveyance rolls 18F and 18G is movable between a position indicated by a solid line and a position indicated by a two-dot chain line.

At the position indicated by the solid line, each of the conveyance rolls 18F and 18G does not come into contact with the conveyed substrate 15 (coated structure 16). Then, each of the conveyance rolls 18F and 18G moves from the position indicated by the solid line to the position indicated by the two-dot chain line to come into contact with the conveyed substrate 15. The control unit 10 controls the movement of the conveyance rolls 18F and 18G and adjusts the respective positions of the conveyance rolls 18F and 18G. In the accumulator 43, a tension acting on the conveyed substrate 15 changes in accordance with the change in the position of the conveyance rolls 18F and 18G.

In the film forming apparatus 1, in the winding unit 5, the coated structure 16 (substrate 15) may be wound around the reel 12 in a state of having a shape other than a perfect circular shape as viewed in the width direction of the conveyance unit 2 (axial direction of the reel 12), and in one example, the coated structure 16 is wound in a state of having an elliptical shape as viewed in the width direction of the conveyance unit 2. In a case where the coated structure 16 is wound in a state of having a shape other than the perfect circular shape as viewed from the width direction of the conveyance unit 2, a speed difference occurs between a peripheral speed at the unwinding of the substrate 15 and a peripheral speed at the winding of the coated structure 16. Therefore, a speed difference occurs in the conveyance speed of the substrate 15 between the upstream side and the downstream side with the accumulator 43 interposed therebetween. Therefore, with adjustment of the positions of the conveyance rolls 18F and 18G, the tension acting on the substrate 15 in the accumulator 43 is adjusted, and the occurrence of slack in the substrate 15 due to the above-described speed difference is suppressed.

In the example of FIG. 1, an insulating tape 46 having electrical insulation is wound around a reel 45. Then, the insulating tape 46 unwound from the reel 45 joins the coated structure 16 (substrate 15) on the conveyance roll 18H disposed on the downstream side of the accumulator 43. Then, in the conveyance roll 18H, the insulating tape 46 is stacked on the coated structure 16, and in the winding unit 5, the coated structure 16 on which the insulating tape 46 is stacked is wound around the reel 12.

In the film forming apparatus 1, the above-described inspection for the substrate 15, the film 17 formed on the substrate 15, and the like may not be performed. In addition, the accumulator 43 may not be provided in the film forming apparatus 1. In addition, in the film forming apparatus 1, the coated structure 16 may be wound in the winding unit 5 in a state where the insulating tape 46 is not stacked.

As described above, in the present embodiment, the substrate 15 is conveyed from the upstream end of the application area A1 to the downstream end of the drying area A2 in a state where the substrate 15 is not in contact with the conveyance roll 18. With such a configuration, after the raw material liquid is applied to the substrate 15 in the application area A1, peeling or the like of the film formed by the raw material liquid from the substrate 15 is effectively prevented. Thus, the film 17 is appropriately formed on the substrate 15 by the film forming processing including application of the raw material liquid to the substrate 15 and drying of the raw material liquid applied to the substrate 15. In particular, with a configuration in which the conveyance roll 18 is not in contact with the substrate 15 over the entire application area A1 and the entire drying area A2, the film 17 is appropriately formed even in a case where the film 17 is formed on both the main surfaces 21 and 22 of the substrate 15.

In the present embodiment, even in a configuration where the conveyance roll 18 is not in contact with the substrate 15 over the entire application area A1 and the entire drying area A2, the substrate 15 is appropriately conveyed in the conveyance unit 2. In particular, in the present embodiment, the conveyance speed of the substrate 15 is adjusted in at least one of the regions located on the upstream side of the application area A1 and on the downstream side of the drying area A2. In addition, the tension acting on the substrate 15 is detected, and the tension acting on the substrate 15 is adjusted based on the detection result in at least one of the regions located on the upstream side of the application area A1 and on the downstream side of the drying area A2. With adjustment of the conveyance speed and adjustment of the tension as described above, the substrate 15 is appropriately conveyed in a state where the substrate 15 does not contact the conveyance roll 18 from the upstream end of the application area A1 to the downstream end of the drying area A2.

In the present embodiment, one or more conveyance rolls 18 including the conveyance roll 18E serve as the position adjustment roll, and the position adjustment roll adjusts the position of the substrate 15 in the width direction of the conveyance unit 2 without generating twisting in the substrate 15. With provision of the position adjustment roll, the occurrence of deviation and meandering of the substrate 15 is effectively suppressed. Therefore, the substrate 15 is appropriately conveyed in the conveyance unit 2.

Here, in the configuration of the example of FIGS. 3 and 4, when a value obtained by subtracting the dimension W0 of the substrate 15 from the dimension W1 of the recess 31 is 1 mm or more (W0+1 mm≤W1), the entire width of the conveyed substrate 15 can be appropriately stored in the recess 31. In addition, when the value obtained by subtracting the dimension W0 of the substrate 15 from the dimension W1 of the recess 31 is 2 mm or less (W1≤W0+2 mm), the deviation (shift) of the substrate 15 in the width direction of the conveyance unit 2 can be suppressed to 1 mm or less relative to a state where the central position of the recess 31 and the central position of the substrate 15 are aligned.

In the configuration of the example of FIGS. 5 and 6, the dimension W2 of the uniform diameter portion 32 is set to 1 mm or more, thereby making it possible to appropriately realize the configuration in which the uniform diameter portion 32 is in contact with the conveyed substrate 15. In addition, since the dimension W2 of the uniform diameter portion 32 is 2 times or less of the dimension W0 of the substrate 15, the deviation of the substrate 15 in the width direction of the conveyance unit 2 can be effectively suppressed. Since the dimension W2 of the uniform diameter portion 32 is equal to or smaller than the dimension W0 of the substrate 15, the deviation of the substrate 15 in the width direction of the conveyance unit 2 can be more effectively suppressed. In a case where the dimension W0 of the substrate 15 is 3 mm or more, a value obtained by subtracting the dimension W2 of the uniform diameter portion 32 from the dimension W0 of the substrate 15 is 2 mm or more (W2≤W0−2 mm (W0≥3 mm)), whereby the deviation (offset) of the substrate 15 in the width direction of the conveyance unit 2 can be suppressed to 1 mm or less relative to a state in which the center position of the uniform diameter portion 32 and the center position of the substrate 15 are aligned.

Further, in the position adjustment of the substrate 15 by the position adjustment roll, the position of the substrate 15 is adjusted without generating torsion in the substrate 15, so that deterioration of the substrate 15 due to the position adjustment is suppressed. In particular, in a case where a superconductor is conveyed as the substrate 15, a configuration in which torsion is not generated in the substrate 15 in position adjustment is adopted so that deterioration of the substrate 15 due to position adjustment is effectively suppressed. In the present embodiment, the control unit 10 adjusts the position of the substrate 15 without controlling the operation of the position adjustment roll.

The conveyance roll 18E, which is one of the position adjustment rolls, is disposed at a position adjacent to t the drying area A2 from the downstream side. Therefore, even when the conveyance roll 18 is configured not to contact the substrate 15 over the entire application area A1 and the entire drying area A2, deviation, meandering, and the like of the substrate 15 are appropriately suppressed in the conveyance unit 2.

In the present embodiment, the raw material liquid is applied to the surface of the substrate 15 by discharging the raw material liquid from the application head 23. This makes it possible to reduce a temperature at which the raw material liquid is dried in the drying area A2. The temperature at which the raw material liquid is dried is reduced so that deterioration of the substrate 15 due to a drying treatment of the raw material liquid is suppressed. In particular, in a case where the superconductor is conveyed as the substrate 15, the deterioration of the substrate 15 due to the drying treatment is effectively suppressed by lowering the temperature at which the raw material liquid is dried.

In one example of the embodiment, the temperature of the substrate 15 is detected in the drying area A2, and the control unit 10 controls the operation of the dryer 25 based on the detection result of the temperature of the substrate 15 so that the temperature of the substrate 15 is lower than a threshold temperature. As a result, deterioration of the substrate 15 due to the drying treatment is further effectively suppressed.

In a preferred example of the embodiment, the diameter of each of the plurality of conveyance rolls 18 is 100 mm or more. As a result, the force acting on the substrate 15 from each of the conveyance rolls 18 is reduced. Therefore, deterioration of the substrate 15 due to the force from the conveyance roll 18 is suppressed.

In the above-described embodiment and the like, the drying area A2 is continuous to the downstream side of the application area A1, and the conveyance roll 18 is not disposed over the entire application area A1 and the drying area A2. However, in a modification, an air turn bar is disposed as the conveyance roll 18 in a range from the upstream end of the application area A1 to the downstream end of the drying area A2. The air turn bar discharges air from the outer peripheral surface. The air turn bar supports the conveyed substrate 15 by a pressure of the discharged air, and supports the substrate 15 without contacting the substrate 15. Therefore, in the present modification in which the air turn bar is disposed in the range from the upstream end of the application area A1 to the downstream end of the drying area A2, similarly to the above-described embodiment, the conveyance unit 2 conveys the substrate 15 in a state where the substrate 15 is not in contact with the conveyance roll 18 from the upstream end of the application area A1 to the downstream end of the drying area A2.

In addition, in the above-described embodiment and the like, a superconductor has been exemplified as an example of the substrate 15 to be conveyed, but the configuration of the film forming apparatus 1 described above is also applicable to a case where electrodes (positive electrode and negative electrode) of a battery and electrodes (positive electrode and negative electrode) of an electrolytic capacitor are conveyed as the substrate 15. In this case, as the separator, the film 17 is formed on the surface of the substrate 15, and a separator-integrated electrode is formed as the coated structure 16.

In a case where torsion may be generated in the substrate 15, such that a separator-integrated electrode is formed as the coated structure 16, the above-described mechanism for correcting meandering and deviation of the substrate 15 by controlling the operation of an operation unit such as a roll guider may be provided in the film forming apparatus 1. In this case, a mechanism for correcting meandering or the like of the substrate 15 using a roll guider or the like is provided in at least one of regions on the upstream side of the application area A1 and on the downstream side of the drying area A2. Even in a case where a mechanism for correcting meandering or the like of the substrate 15 using a roll guider or the like is provided, one or more of the conveyance rolls 18 serves as a position adjustment roll and adjusts the position of the substrate 15 in the width direction of the conveyance unit 2 without generating twisting in the substrate 15.

Further, the configuration in which the substrate 15 is not in contact with the conveyance roll 18 from the upstream end of the application area A1 to the downstream end of the drying area A2, the position adjustment of the substrate 15 in the width direction of the conveyance unit 2 by the position adjustment roll, and the like are also applicable to the case of applying the raw material liquid to the substrate 15 by a method other than the discharge of the raw material liquid from the application head. In one example, in the application area A1, the substrate 15 is conveyed through a liquid tank in which the raw material liquid is stored, and the raw material liquid is applied to the substrate 15 by electrodeposition. Even in a case where the substrate 15 is applied with the raw material liquid by electrodeposition, a configuration in which the substrate 15 does not contact the conveyance roll 18 from the upstream end of the application area A1 to the downstream end of the drying area A2, position adjustment of the substrate 15 in the width direction of the conveyance unit 2 by the position adjustment roll, and the like can be applied.

According to at least one of these embodiments or examples, the conveyance unit conveys the substrate in a state where the substrate does not contact the conveyance roll from the upstream end of the application area to the downstream end of the drying area. Further, according to at least one of these embodiments or examples, the conveyance roll includes a position adjustment roll that adjusts the position of the substrate in the width direction of the conveyance unit without generating torsion in the substrate. With inclusion of any of these configurations, there can be provided the film forming apparatus that appropriately conveys the substrate and appropriately forms the film on the substrate by the film forming processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A film forming apparatus, comprising:
an application unit that applies a raw material liquid to a surface of a substrate;
a drying unit that dries the raw material liquid applied to the substrate by the application unit; and
a conveyance unit that includes a conveyance roll capable of supporting the substrate, and conveys the substrate by passing through an application area in which the raw material liquid is applied by the application unit and a drying area in which the raw material liquid is dried by the drying unit in order from an upstream side, the conveyance unit conveying the substrate in a state where the substrate is not in contact with the conveyance roll from an upstream end of the application area to a downstream end of the drying area.

2. The film forming apparatus according to claim 1, wherein the drying area is continuous to a downstream side of the film area in the conveyance unit.

3. The film forming apparatus according to claim 1, wherein the conveyance roll of the conveyance unit includes a position adjustment roll that adjusts a position of the substrate in a width direction of the conveyance unit without generating torsion in the substrate, and
the position adjustment roll is disposed at least at a position adjacent to the drying area from the downstream side.

4. A film forming apparatus, comprising:
an application unit that applies a raw material liquid to a surface of a substrate;
a drying unit that dries the raw material liquid applied to the substrate by the application unit; and
a conveyance unit that includes a conveyance roll capable of supporting the substrate, and conveys the substrate by passing through an application area in which the raw material liquid is applied by the application unit and a drying area in which the raw material liquid is dried by the drying unit in order from an upstream side, the conveyance roll including a position adjustment roll that adjusts a position of the substrate in a width direction of the conveyance unit without generating torsion in the substrate.

5. The film forming apparatus according to claim 4, wherein the position adjustment roll includes a recess recessed toward an inner peripheral side, and supports the substrate in a state where a full width of the substrate is accommodated in the recess.

6. The film forming apparatus according to claim 4, wherein
the position adjustment roll includes:
a uniform diameter portion having a uniform outer diameter;
a first tapered portion that is adjacent to the uniform diameter portion from one side in the width direction of the conveyance unit and has an outer diameter decreasing as a distance from the uniform diameter portion increases; and
a second tapered portion that is adjacent to the uniform diameter portion from a side opposite to the first tapered portion in the width direction of the conveyance unit, and has an outer diameter decreasing as a distance from the uniform diameter portion increases, wherein
the position adjustment roll supports the substrate in a state where the uniform diameter portion is in contact with the substrate.
